(19) United States
(12) Patent Application Publication
(10) Pub. No.: US 2011/0237144 A1
(43) Pub. Date: Sep. 29, 2011

(54) PHOSPHORUS FLAME RETARDANTS AND APPLICATIONS THEREFOR

(75) Inventors: Hoover B. Chew, Summerville, SC (US); William J. Layman, JR., Baton Rouge, LA (US); Arthur G. Mack, Prairieville, LA (US); Ravindra R. Joshi, Stevenson Ranch, CA (US)

(73) Assignee: ALBEMARLE CORPORATION, Baton Rouge, LA (US)

(21) Appl. No.: 13/132,764

(22) PCT Filed: Dec. 8, 2009
(86) PCT No.: PCT/US09/67183

§ 371 Date: Jun. 3, 2011

Related U.S. Application Data
(60) Provisional application No. 61/120,676, filed on Dec. 8, 2008.

(51) Int. Cl. B32B 9/04; C08L 75/04; C09K 21/12

(52) U.S. Cl. 442/136; 521/85; 252/609

(57) ABSTRACT

This invention relates to a phosphorus flame retardant composition formed from bringing together components comprising: a) a cyclic phosphanate flame retardant comprising (5-ethyl-2-methyl-2-oxido-1,3,2-dioxaphosphorinan-5-yl)methyl methyl ester of P-alkylphosphonic acid, and bis[(5-ethyl-2-methyI-2-oxido-1,3,2-dioxaphosphorinan-5-yl)methyl]ester of P-alkylphosphonic acid; and b) an alkylated triaryl phosphate ester flame retardant having a triphenyl phosphate (TTP) content of less than about 1 wt % based on the total weight of the alkylated triaryl phosphate ester. This invention further relates to the use of this phosphorus flame retardant composition especially for in polyurethane foams and textile applications.

### TECHNICAL FIELD

This invention relates to phosphorus-containing flame retardants, and the use of these phosphorus-containing flame retardants in applications such as flexible polyurethane foams, rigid polyurethane foams and textiles.

### BACKGROUND

Alkylated aryl phosphates are known in the art to be useful as flame-retardants. These compounds can be formed by a number of methods commonly used in the art. For example, it is known to prepare mixed synthetic triaryl phosphates by alkylating phenol with alkenes such as propylene or isobutylene to obtain a mixture of phenol and substituted phenols. According to U.S. Pat. No. 4,093,680 this alkylate mixture is then reacted with phosphorus oxychloride (POCl₃) to form a mixed triaryl phosphate ester. The product mix is a statistical mixture based on the composition of the starting alkylates and always includes some fraction of triphenyl phosphates (“TPP”), usually from 5 to 50 percent.

Triphenyl phosphates (TPP) is an excellent fire retardant component and alkylated aryl phosphates flame retardants with low TPP content are generally not effective. However, TPP has been classified as a marine pollutant in some jurisdictions and thus there has been much attention in the art given to removing TPP from alkylated aryl phosphates. For example, U.S. Pat. No. 5,206,404 and PCT International Publication Number WO2007/127691 disclose methods that can be used to produce mixed alkylated triphenyl phosphates with low TPP concentrations.

Effective cyclic phosphanate flame retardant flame retardants are also known in the industry. One example is Amguard™ CU, which a mixture of the (5ethyl-2-methyl-2-oxido-1,3,2-dioxaphosphorinan-5-yl)methyl methyl ester of P-methylphosphonic acid (˜3.5 parts) and bis[(5-ethyl-2-methyl-2-oxido-1,3,2-dioxaphosphorinan-5-yl)methyl]ester of P-methylphosphonic acid (˜1 part). Alternative nomenclature for the components in Amguard Cu are Phosphonic acid, methyl-, (5-ethyl-2-methyl-1,3,2-dioxaphosphorinan-5-yl)methyl methyl ester, P-oxide (Cas # 41203-81-0) and Phosphonic acid, methyl-, bis[(5-ethyl-2-methyl-1,3,2-dioxaphosphorinan-5-yl)methyl ester, P,P′-dioxide (Cas # 42595-45-9).

Flame retardants are often included in polyurethane foams. More particularly, because flexible polyurethane foams and rigid polyurethane foams are in widespread use, much research has been done on providing flame retardancy to these foams. However, the art is always striving for suitable flame retardants that outperform or have more favorable characteristics than those currently available for both flexible polyurethane foams and rigid polyurethane foams.

Another area in which flame retardants are used is in textiles. Commercial textile products are often required to meet flame retardant standards or to pass certain flame retardancy tests. A variety of materials have been used to impart flame retardant properties to textiles. For example, U.S. Pat. No. 7,011,724 describes the use of intumescent particles in the back-coating of carpet to impart flame retardant properties to the carpet. In some instances, specific brominated or phosphorus-based flame retardants are mentioned for use with blends of cotton and polyester fibers (see U.S. Pat. Nos. 3,997,699 and 4,167,603). In other cases, the textile itself is comprised of fibers having flame retardant or smoke suppressant properties; see for example U.S. Pat. No. 4,012,546. As mentioned above in connection with polyurethane foams, the art is always striving for suitable flame retardants that outperform or have more favorable characteristics than those currently available for use with textiles.

### SUMMARY OF THE INVENTION

This invention relates to a phosphorus flame retardant composition formed from bringing together components comprising: a) a cyclic phosphanate flame retardant comprising (5-ethyl-2-methyl-2-oxido-1,3,2-dioxaphosphorinan-5-yl)methyl methyl ester of P-alkylphosphonic acid (Cas # 41203-81-0), and bis[(5-ethyl-2-methyl-2-oxido-1,3,2-dioxaphosphorinan-5-yl)methyl]ester of P-alkylphosphonic acid (Cas# 42595-45-9); and b) an alkylated triaryl phosphate ester flame retardant having a biphenyl phosphate (TTP) content of less than about 1 wt % based on the total weight of the alkylated triaryl phosphate ester.

This invention further relates to the use of this phosphorus flame retardant composition especially in polyurethane foams and textile applications.

### FURTHER DETAILED DESCRIPTION OF THE INVENTION

An embodiment of this invention is a phosphorus flame retardant composition. The phosphorus flame retardant composition is formed by bringing together components which comprise: a) a cyclic phosphanate flame retardant comprising (5-ethyl-2-methyl-2-oxido-1,3,2-dioxaphosphorinan-5-yl)methyl methyl ester of P-alkylphosphonic acid, and bis[(5-ethyl-2-2-methyl-2-oxido-1,3,2-dioxaphosphorinan-5-yl)methyl]ester of P-alkylphosphonic acid; and b) an alkylated triaryl phosphate ester flame retardant having a triphenyl phospate (TTP) content of less than about 1 wt % based on the total weight of the alkylated triaryl phosphate ester.

Another embodiment of the present invention is when the amount of the cyclic phosphanate flame retardant is about 8 wt % to about 11.5 wt % based on the total weight of the cyclic phosphanate flame retardant and alkylated triaryl phosphate ester flame retardant.

Another embodiment is when the two diesters of of the cyclic phosphanate flame retardant are P-alkylphosphonic acid are diesters of P-methylphosphonic acid.

Another embodiment is when the cyclic phosphonate flame retardant contains in the range of from about 60 wt. % to about 90 wt. %, or about 70 wt. % to about 85 wt. %, (5-ethyl-2-methyl-2-oxido-1,3,2-dioxaphosphorinan-5-yl)methyl methyl ester of P-alkylphosphonic acid (monomer), and in the range of from about 10 wt. % to about 40wt. %, or about 15 wt. % to about 30 wt. %, of bis[(5-ethyl-2-methyl-2-oxido-1,3,2-dioxaphosphorinan-5-yl)methyl]ester of P-alkylphosphonic acid (dimer), based on the total weight of the monomer and dimmer.

Another embodiment is when the alkylated triaryl phosphate ester contains one or more of the following alkylated phenyl phosphates: a) monoalkylphenyl diphenyl phosphates; b) di-(alkylphenyl) phenyl phosphates; c) dialkylphenyl diphenyl phosphates; d) trialkylphenyl phosphates; e) alkylphenyl dialkylphenyl phenyl phosphates, wherein the alkyl moieties of the alkylated phenyl phosphates and TPP are selected from methyl, ethyl, n-propopyl, isopropyl, isobutyl, tertiary-butyl, isoamyl and tertiary-amyl groups.

Another embodiment is when the alkylated triaryl phosphate ester comprises in the range of from about at 90 to about 92 wt. % an isopropylphenyl diphenyl phosphate, in the range of from about 0.5 to about 0.75 wt. % tri(isopropylphenyl)phosphate, in the range of from about 1 to about 3 wt. % di-(isopropylphenyl)phenyl phosphate, in the range of from about 0.05 to about 0.15 wt. % triphenyl phosphate, and in the range of from about 0.5 to about 0.75 wt. % di-isopropylphenyl diphenyl phosphate; or b) in the range of from about 94 to about 96 wt. % isopropylphenyl diphenyl phosphate, in the range of from about 3.5 to about 5.5 wt. % di-(isopropylphenyl)phenyl phosphate, and in the range of from about 0.1 to about 0.3 wt. % tri(isopropylphenyl)phosphate; or c) in the range of from about 71 to about 73 wt. % isopropylphenyl diphenyl phosphate, in range of from about 0.05 to about 0.15 wt. % triphenyl phosphate, in the range of from about 26 to about 28 wt. % di-(isopropylphenyl)phenyl phosphate, and in the range of from about 0.5 to about 0.7 wt. % tri(isopropylphenyl)phosphate.

This invention also relates to the use of the phosphorus flame retardant composition above in a polyurethane foam composition where the polyurethane foam composition comprises: a) the phosphorus flame retardant composition; b) an isocyanate or polyisocyanate; a polyol along with at least one surfactant, d) at least one blowing agent, and e) at least one catalyst.

One embodiment of the polyurethane foam composition is when the foam is a flexible polyurethane foam, the polyol is a polyether polyol. Another embodiment of the polyurethane foam composition is when the foam is a rigid polyurethane foam and the polyol has a hydroxyl number in the range of about 150 to about 850 mg KOH/g.

This invention also relates to the use of the phosphorus flame retardant composition above in a textile application to which the phosphorus flame retardant composition has been applied. One embodiment is when textile has a back-coating, and wherein said phosphorus flame retardant composition is included in said back-coating.

This invention also relates to the use of the phosphorus flame retardant in a coating, adhesive, sealer or elastomer and where the article comprises the phosphorus flame retardant composition of the present invention.

As used throughout this document, the abbreviation “php” stands for parts (by weight) per hundred polyol.

In the cyclic phosphonate flame retardant, there are two P-alkylphosphonic acid diesters. One diester has one (5-ethyl-2-methyl-2-oxido-1,3,2-dioxaphosphorinan-5-yl)methyl ester group, and the other diester has two (5-ethyl-2-methyl-2-oxido-1,3,2-dioxaphosphorinan-5-yl)methyl ester groups. In the P-alkylphosphonic moiety of the P-alkylphosphonic acid diesters, the alkyl group has one to about six carbon atoms. Examples of suitable alkyl groups include methyl, ethyl, n-propyl, isopropyl, n-butyl, sec-butyl, pentyl, hexyl, and the like. Preferred alkyl groups for the P-alkylphosphonic moiety include methyl and ethyl (so the P-alkylphosphonic moiety is P-methylphosphonic or P-ethylphosphonic), with methyl being more preferred. For the diester which has one (5-ethyl-2-methyl-2-oxido-1,3,2-dioxaphosphorinan-5-yl)methyl ester group, the alkyl ester group has one to about six carbon atoms. Suitable alkyl groups include methyl, ethyl, n-propyl, isopropyl, n-butyl, sec-butyl, pentyl, hexyl, and the like. Preferred alkyl groups for the alkyl ester include methyl and ethyl, with methyl being more preferred. Particularly preferred P-alkylphosphonic acid diesters in the practice of this invention are the (5-ethyl-2-methyl-2-oxido-1,3,2-dioxaphosphorinan-5-yl)methyl methyl ester of P-methylphosphonic acid (CAS No. 41203-81-0) and the bis[(5-ethyl-2-methyl-2-oxido-1,3,2-dioxaphosphorinan-5-yl)methyl]ester of P-methylphosphonic acid (CAS No. 42595-45-9).

Proportions of the P-alkylphosphonic acid diester having one (5-ethyl-2-methyl-2-oxido-1,3,2-dioxaphosphorinan-5-yl)methyl ester group to P-alkylphosphonic acid diester having two (5-ethyl-2-methyl-2-oxido-1,3,2-dioxaphosphorinan-5-yl)methyl ester groups can be in the range of about 25:1 to about 1:5, or about 10:1 to about 1:1, or about 5:1 to about 2:1. In the practice of this invention, a particularly preferred ratio of P-alkylphosphonic acid diester having one (5-ethyl-2-methyl-2-oxido-1,3,2-dioxaphosphorinan-5-yl)methyl ester group to P-alkylphosphonic acid diester having two (5-ethyl-2-methyl-2-oxido-1,3,2-dioxaphosphorinan-5-yl)methyl ester groups is about 3.35-3.55:1.

The alkylated triaryl phosphate ester flame retardant of the present invention with TPP concentration of less than about 1 wt % may be produced by methods in, for example, U.S. Pat. No. 5,206,404 and PCT International Publication Number WO2007/127691, herein incorporated by reference in their entirety. The method used in PCT International Publication Number WO2007/127691 is preferred. In that publication, a process for making the low TPP alkylated triaryl phosphate esters is disclosed whereby the method comprises reacting an alkylated phenol comprising less than about 1 mole % phenol and up to about 25 mole % dialkyl phenol, both based on the total moles of reactive alkylated phenolics in the alkylated phenol, with POCl₃ in the presence of a first catalyst under first reaction conditions including temperatures ranging from about 80° C. to about 210° C. thereby producing a first reaction product comprising greater than about 75 mole % monoalkylated phenyl-dichloro phosphates, based on the total moles of the first reaction product; and reacting the first reaction product with an alcohol selected from aryl alcohols, alkyl alcohols, alkylated aryl alcohols, and mixtures thereof in the presence of a second catalyst under second reaction conditions including temperatures ranging from about 90° C. to about 260° C. thereby producing an alkylated triaryl phosphate ester.

The phosphorus flame retardant composition can be prepared by bringing together the ingredients thereof in any order. Preferably, the ingredients are mixed or blended by conventional means to ensure a relatively uniform mixture.

As mentioned above, an embodiment of this invention is a method of producing a polyurethane foam composition. The method comprises including a flame retardant amount of a phosphorus flame retardant composition of the invention in a polymerization formulation comprised of

i) isocyanate and polyol along with at least one surfactant, at least one blowing agent, at least one catalyst, and reacting the mixture to form a flexible polyurethane foam; or
ii) polyisocyanate and polyol along with at least one surfactant, at least one blowing agent, at least one catalyst, and reacting the mixture to form a rigid polyurethane foam.

To provide flame retardancy to polyurethane foams, the phosphorus flame retardant composition is typically included as one the additives employed in the polyurethane foam formation process. The polyurethane foam is usually formed under normal polyurethane foam formation conditions and normal polyurethane foam formation methods/processes. For more information regarding the formation of polyurethane foams, see for example U.S. Pat. Nos. 3,954,684; 4,209,609; 5,356,943; 5,561,180; and 6,121,338.

Flexible polyurethane foams are typically formed by bringing together two liquids, isocyanates and polyols. The polyols are polyether or polyester polyols. The reaction readily occurs at room temperature in the presence of a blowing agent such as water, a volatile hydrocarbon, halocarbon, or halohydrocarbon, or mixtures of two or more such materials. Catalysts used in effecting the reaction include amine catalysts, tin-based catalysts, bismuth-based catalysts or other organometallic catalysts. Surfactants such as substituted silicone compounds are often used in order to maintain homogeneity of the cells in the polymerization system. Preferred catalysts include triethylenediamine (33%) in dipropylene glycol, and stannous octoate.

Hindered phenolic antioxidants, e.g., 2,6-di-tert-butyl-para-cresol and methylenebis(2,6-di-tert-butylphenol), can be used to further assist in stabilization against oxidative degradation. These and other ingredients that can be used, and the proportions and manner in which they are used are reported in the literature. See for example: Herrington and Hock, Flexible Polyurethane Foams, The Dow Chemical Company, 1991, 9.25-9.27 or Roegler, M. “Stabstock Foams”; in Polyurethane Handbook; Oertel, G., Ed.; Hanser Munich, 1985, 176-177 or Woods, G. Flexible Polyurethane Foams, Chemistry and Technology; Applied Science Publishers, London, 1982, 257-260.

For example, the flexible polyurethane foams can be prepared by the one-hot process, the quasi- or semi-prepolymer process, or the prepolymer process. Further, the flexible polyurethane foams may be used to form articles such as molded foams, slabstock foams, and may be used as cushioning material in furniture and automotive seating, in mattresses, as carpet backing, as hydrophilic foam in diapers, and as packaging foam.

Rigid polyurethane foams are usually formed by bringing together polyisocyanates with compounds having isocyanate-reactive hydrogen atoms and optionally chain extenders or cross linkers in amounts such that the equivalent ratio of isocyanate groups versus the sum of the isocyanate-reactive hydrogen atoms of the components ranges from about 0.85 to about 30:1, and preferably from about 0.95:1 to about 4:1.

To form a rigid polyurethane foam, a foam-producing amount of at least one blowing agent is included in the reaction mixture before the polymer has been formed. Rigid foams have a density in the range of about 20 kg/m³ to about 100 kg/m³, preferably about 25 kg/m³ to about 80 kg/m³, and more preferably about 30 kg/m³ to about 45 kg/m³. The amount of blowing agent usually determines the density of rigid foams. The amount will typically fall in the range of 1 to 10 percent by weight based on the total weight of the reaction mixture being foamed.

The mechanical properties of the rigid polyurethane foams can be modified by using chain extenders or cross-linkers in the preparation of the rigid polyurethane foams of this invention. Suitable chain extenders and/or cross-linkers are diols and/or triols with molecular weights lower than 250 and particularly between 50 and 200. Suitable diols include aliphatic, cycloaliphatic, or aromatic types, e.g., ethylene glycol, diethylene glycol, dipropylene glycol, and 1,4 butanediol. Suitable trials include, but are not limited to, trimethylolpropane and glycerine. When chain extenders and/or cross-linkers are used to form rigid polyurethane foams, the chain extenders and/or cross-linkers are normally applied in a loading of 0 to about 20 weight percent and preferably about 2 to about 10 weight percent relative to the weight of the polyols.

In the forming the polyurethane teams of the invention, a flame retardant amount of the phosphorus flame retardant composition is used. By a flame retardant amount is meant that amount of the phosphorus flame retardant composition needed to obtain the desired level of flame retardancy. At least for flexible polyurethane foams, a flame retardant amount is typically in the range of about 3 php to about 15 php, preferably is in the range of about 3 php to about 10 php, and more preferably is in the range of about 3 php to about 6 php.

It has been observed in the practice of this invention, at least for work with flexible polyurethane foams, that the loading of the phosphorus flame retardant composition can be reduced by about 50% in comparison to that of some conventional flame retardants (e.g., Firemaster™ 550), and that the polyurethane foam formed with this lower loading of the phosphorus flame retardant composition passed the flame retardance test of California Technical Bulletin 117. Polyurethane foams made using the lower loading of phosphorus flame retardant composition have better physical properties (e.g., tensile strength, tear strength, and elongation).

The phosphorus flame retardant composition and preferences therefor for inclusion when forming either flexible or rigid polyurethane foams are as described above for the phosphorus flame retardant compositions of the invention.

Chemicals which have been widely used as blowing agent in the production of polyurethane foam are the fully halogenated chlorofluorocarbons, and in particular trichlorofluoromethane (CFC-11). The exceptionally low thermal conductivity of these blowing agents, and in particular of CFC-11, has enabled the preparation of rigid foams having very effective insulation properties. If desired, such blowing agents can be used in the practice of this invention unless prohibited from use by law. As noted above, recent concern over the potential of chlorofluorocarbons to cause depletion of ozone in the atmosphere has led to an urgent need to develop reaction systems in which chlorofluorocarbon blowing agents are replaced by alternative materials which are environmentally acceptable and which also produce foams having the necessary properties for the many applications in which they are used. Initially, the most promising alternatives appeared to be hydrogen-containing chlorofluorocarbons (HCFC's) such as 1,1-dichloro-1-fluoroethane (HCFC-141b). However, HCFC's also have some ozone-depletion potential. There is therefore mounting pressure to find substitutes for the HCFC's as well as the CFC's. Nevertheless, such blowing agents can be used in the practice of this invention to the extent their use is not prohibited by law.

Suitable blowing agents in the practice of this invention when forming flexible polyurethane foams include water, a volatile hydrocarbon, halohydrocarbon, or halocarbon, or mixtures of any two or more of these. Preferred blowing agents for flexible polyurethane foams include combinations of water with methylene chloride, Freon 11, or acetone, in a weight ratio of water to the other component of the combination in the range of about 1:2 to about 2:1; water and methylene chloride are a preferred combination.

For forming rigid polyurethane foams, blowing agents which can be used in the practice of this invention include partially fluorinated hydrocarbons (HFC's) and hydrocarbons (HC's). Water can also be used as a single blowing agent or as a co-blowing agent in combination HCFC-, HFC- or HC blowing agents. Water will react with the isocyanate groups and form urea structures and release carbon dioxide.

The polyol or polyols used in forming the polyurethane foams in the practice of this invention can be any polyol that can be used to produce flexible polyurethane foams or rigid polyurethane foams. When flexible polyurethane foam is being formed, the polyol usually is a polyol or mixture of polyols having hydroxyl numbers up to about 150 mg KOH/g, preferably in the range of 0 to about 100 mg KOH/g, and more preferably in the range of about 10 to about 100 mg KOH/g. Suitable polyols for flexible polyurethane foams include polyether polyols. In the practice of this invention, preferred polyols for forming flexible polyurethane foams include Voranol® 3010 polyol, (a polyether polyol having a molecular weight of about 3000 and a hydroxyl number of about 56 mg KOH/g; The Dow Chemical Company, Midland, Mich.), Pluracol® 1718 polyol, (a polyether polyol having a molecular weight of about 3000 and a hydroxyl number of about 58 mg KOH/g; BASF Corporation, Florham Park, N.J.), and Pluracol® 1388 polyol (a polyether triol having a molecular weight of about 3100; BASF Corporation, Florham Park, N.J.).

For forming rigid polyurethane foams of this invention, individual or mixtures of polyols with hydroxyl numbers in the range of about 150 to about 850 mg preferably in the range of about 200 to about 600 mg KOH/g, and having hydroxyl functionalities in the range of about 2 to about 8, preferably in the range of about 3 to about 8, are used. Suitable polyols meeting these criteria have been fully described in the literature, and include reaction products of (a) alkylene oxides such as propylene oxide and/or ethylene oxide, with (b) initiators having in the range of about 2 to about 8 active hydrogen atoms per molecule. Suitable initiators include, for example, diols (e.g., diethylene glycol, bisphenol-A), polyesters (e.g., polyethylene terephthalate), triols (e.g., glycerine), novolac resins, ethylenediamine, pentaerythritol, sorbitol, and sucrose. Other suitable polyols include polyesters prepared by the condensation reaction of appropriate proportions of glycols and higher functionality polyols with dicarboxylic or polycarboxylic acids. Still other suitable polyols include hydroxyl-terminated polythioethers, polyamides, polyesteramides, polycarbonates, polyacetals and polysiloxanes. A preferred polyol for forming rigid polyurethane foams is a polyester polyol.

In the practice of this invention, when brining flexible polyurethane foams, the isocyanate can be any isocyanate that is normally used to produce flexible polyurethane foams. Generally, the isocyanate has at least one isocyanate group, more preferably two isocyanate groups, and molecules having more than two isocyanate groups can be utilized. Preferably, diisocyanates are used. The isocyanates used herein can be aliphatic or aromatic isocyanates. Examples of isocyanates that can be used for forming flexible polyurethane foams in the practice of this invention include, but are not limited to, 1,4-tetramethylene diisocyanate, 1,5-pentamethylene diisocyanate, 2-methyl-1,5-pentamethylene diisocyanate, 1,6-hexamethylene diisocyanate, (HMDI), 1,7-heptamethylene diisocyanate, 1,10-decamethylene diisocyanate, cyclohexylene diisocyanate, isophorone diisocyanate (IPDI), 2,2,4-trimethylhexamethylene diisocyanate, 2,4,4-trimethylhexamethylene diisocyanate, 4,4′-methylenebis(cyclohexylisocyanate), phenylene diisocyanate, toluene diisocyanate (TDI), xylene diisocyanate, other alkylated benzene diisocyanates, 1,5-naphthalene diisocyanate, diphenylmethane diisocyanate (MDI, sometimes called methylene diisocyanate), and mixture of any two or more of these. Preferred isocyanates for flexible polyurethane foams include toluene diisocyanate and diphenylmethane diisocyanate.

Suitable polyisocyanates for use in the practice of this invention when forming rigid polyurethane foams include any of those known in the art for the preparation of rigid polyurethane foams. When forming rigid polyurethane foams, the polyisocyanate can be aromatic or aliphatic, and the polyisocyanate can be as diisocyanate, triisocyanate, tetraisocyanate, and or a polymeric polyisocyanate. Diisocyanates are a preferred type of polyisocyanate. Suitable polyisocyanates include phenylene diisocyanate, 2,4-toluene diisocyanate, 2,6-toluene diisocyanate, mixtures of 2,4- and 2,6-toluene diisocyanate, other alkylated benzene diisocyanates, bitoluene diisocyanate, 1,5-naphthalene diisocyanate, 1-methoxyphenyl-2,4-diisocyanate, 4,4′-diphenylmethane diisocyanate, 4,4′-biphenylene diisocyanate, 3,3′-dimethoxy-4,4′-biphenylene diisocyanate, 3,3′-dimethyl-4,4′-biphenyl diisocyanate 3,3′-dimethyldiphenylmethane-4,4′-diisocyanate, 4,4′,4″-triphenylmethane triisocyanate, toluene 2,4,6-triisocyanate, 4,4′-dimethyldiphenylmethane-2,2′,5,5′-tetraisocyanate, polymeric polyisocyanates such as polymethylene polyphenylene polyisocyanate, 1,4-tetramethylene diisocyanate, 1,5-pentamethylene diisocyanate, 1,6-hexamethylene diisocyanate, 1,7-heptamethylene diisocyanate, 2-methyl-1,5-pentamethylene diisocyanate, 1,10-decamethylene diisocyanate, cyclohexylene diisocyanate, hexahydrotoluene diisocyanate and isomers thereof, isophorone diisocyanate, 4,4′-methylenedicyclohexyl diisocyanate (H12MDI), 2,2,4- and 2,4,4-trimethylhexamethylene diisocyanate, and mixtures of any two or more of the foregoing. Preferred polyisocyanates for forming rigid polyurethane foams include toluene diisocyanate.

Catalyst systems for knitting flexible polyurethane foams include amine catalysts such as dimethylethyl amine, triethylene diamine, and bis(dimethylaminoethyl)ether. A preferred catalyst system is a combination or blend of amine catalysts such as a blend of dimethylethyl amine, triethylene diamine, and bis(dimethylaminoethyl)ether. The catalysts are usually used in amounts of about 0.001 to about 2 parts by weight per 100 parts by weight of the polyol(s).

Catalysts for rigid polyurethane foam formation can be categorized as gel catalysts, blow catalysts, balanced gel/blow catalysts and trimerization catalysts. Gel catalysts promote the reaction between the reactive hydrogen atoms, particularly of the hydroxyl groups, and the modified polyisocyanates. Blow catalysts promote the reaction of the reactive hydrogen of water and the modified polyisocyanate. Suitable catalysts are tertiary amines, which can be used as a single catalyst. Examples of suitable tertiary amines as blowing catalyst include, e.g., bis(dimethylaminoethyl)ether and pentamethyldiethylenetriamine. Examples of gel catalysts include 1,4-diaza(2,2,2)bicyclooctane, tetramethyldipropylentriamine, and tris(dimethylarninopropyl)hydrotriazine. Examples of balanced catalysts include dimethylcyclohexylamine, pentamethyldipropylenetriamine, and tris(dimethylaminopropyl)hydrotriazine. The catalysts are usually used in amounts of about 0.001 to about 2 parts by weight per 100 parts by weight of the polyol(s).

One or more optional additives can be included when forming either a flexible or a rigid polyurethane foam. Such optional additives include surfactants, antioxidants, diluents, chain extenders or cross-linkers, synergists (preferably melamine), stabilizers, coloring agents, fillers, antistatic agents, cell openers, and plasticizers.

Cell openers, a particular type of surfactant, are typically polyalkylene oxides. Suitable polyalkylene oxide cell openers in the practice of this invention include polyethylene glycol monoallyl ether, polyethylene glycol allyl methyl diether, polyethylene glycol monoallyl ether acetate, polyethylene glycol monomethyl ether, polyethylene glycol glycerol ether, polyethylene-polypropylene glycol monoallyl ether, polyethylene-polypropylene glycol monoallyl monomethyl diether, and polyethylene-polypropylene glycol allyl ether acetate. Preferred cell openers include Tegostab® B 8239, Evonik Industries AG, Essen, Germany and Tegostab® B 8229, Evonik Industries, Essen, Germany).

Surfactants can be used in forming rigid polyurethane foams as well, if desired. They serve as a surface-active substance in order to improve the compatibility of the various components of the formulation and to control the cell structure. Examples of suitable surfactants are emulsifiers such as sodium salts of castor oil sulfates or fatty acids; fatty acid salts with amines, e.g., diethylamine oleate and diethanolamine stearate; salts of sulfonic acids, e.g., alkali metal or ammonium salts of dodecylbenzenedisulfonic acid and ricinoleic acid; foam stabilizers such as siloxaneoxyalkylene copolymers and other organopolysiloxanes, ethoxylated alkylphenols, ethoxylated fatty alcohols and castor oil.

These surface-active substances are usually used in amounts of from 0.01 to 5 parts by weight based on 100 parts by weight of polyol blend.

Substances and proportions in the flexible and rigid polyurethane foams, including preferences for such substances and the proportions thereof, are as described above for the methods of formation of the flexible and rigid polyurethane foams, respectively.

Another embodiment of this invention is a textile to which a phosphorus flame retardant composition of this invention has been applied. The terms “textile” and “textiles”, as used herein, refer to any fabric, filament, staple, or yarn, or product made therefrom, whether woven or non-woven, and all fabrics, cloths, carpets, etc., made from synthetic and/or natural fibers, especially polyamides, acrylics, polyesters, and blends thereof, cellulosic textile materials including cotton, corduroy, velvet brocade, polyester-cotton blends, viscose rayon, jute, and products made from wood pulp. Suitable textiles in the practice of this invention include natural and/or synthetic carpets; fabric and/or cloth made from synthetic fibers such as polyesters, polyamides, nylons, acrylics, etc.; fabric and/or cloth made from natural fibers such as cotton; and fabric and/or cloth made from blends of synthetic fibers and natural fibers such as cotton/polyester blends. In some embodiments of this invention, the natural and/or synthetic fibers that make up the textiles of the present invention can also be flame retarded, as mentioned above.

In some applications, commercial textile products consist of at least two distinct components, a textile material and a back-coating material. The back-coating material, sometimes referred to as a backing layer or blocking sheet, is used to impart flame retardant properties to a given textile product. For instance, transportation upholstery material is used in conjunction with separate fire blocking, sheet layers. As another example, many carpets include secondary or tertiary backing layers that have flame retardant properties.

This invention also provides a method for imparting flame retardancy to a textile, which method comprises applying to said textile a phosphorus flame retardant composition of this invention. The method of application of the phosphorus flame retardant composition to textiles will vary with the particular textile and application (e.g., carpet or upholstery), and can be the same method used in the art for the application of other flame retardants. As described above for the polyurethane foams, the loading a the phosphorus flame retardant composition for textiles is expected to be significantly lower as compared to that of various conventional flame retardants in order to provide is similar level of flame retardancy.

In textiles and in the methods for applying the phosphorus-containing mixture to textiles, the phosphorus flame retardant compositions are described above, including the preferences therefor.

In some embodiments, the phosphorus flame retardant composition is contained in a layer such as a backing, back layer, or back-coating, referred to collectively herein as back-coating, that is applied to a surface of a textile. The back-coating is typically derived from a polymer compound and as suitable liquid carrier material in which the phosphorus flame retardant composition is dispersed. The liquid carrier material can be any suitable liquid carrier material commonly used in producing back-coatings such as organic liquids and water, as long as such liquid carrier does not adversely affect the phosphorus flame retardant composition. In some embodiments, the liquid carrier material is water.

The back-coating is typically formed by combining the polymer, liquid cattier material, optional components, if any, and the phosphorus flame retardant composition in any manner and order desired. The method and order are not critical to the instant invention. Further, the back-coating can be applied to the surface of the textile through any means known in the art. For example, the use of coating machines such as those utilizing pressure rolls and chill rolls can be used, as can “knife” coating methods, coating methods, extrusion, transfer methods, coating, spraying, foaming, and the like. The amount of back-coating applied to the textile is generally that amount sufficient to provide for a textile having a flame retarding amount of the phosphorus flame retardant composition, as described above. After application of the back-coating, the back-coating can be cured on the textile by heating or drying or by another method to cause the desired reaction in the back-coating.

Generally, the polymer that forms the back-coating for the textile can be selected from any of a large number of stable polymeric dispersions known and used for binding, coating, impregnating, or related uses, and may be of a self-crosslinking type or an externally crosslinked type. The polymer can be an addition polymer, a condensation polymer, or a cellulose derivative. Non-limiting examples of suitable polymers include foamed or unfoamed organosols, plastisols, lattices, and the like, which contain one or more polymeric constituents of types which include vinyl halides such as polyvinyl chloride, polyvinyl chloride-polyvinyl acetate and polyethylene-polyvinyl chloride; polymers and copolymers of vinyl esters such as polyvinyl acetate, polyethylene-polyvinyl and polyacrylic-polyvinyl acetate; polymers and copolymers of acrylate monomers such as ethyl acrylate, methyl acrylate, butyl acrylate, ethylbutyl acrylate, ethylhexyl acrylate, hydroxyethyl acrylate and dimethylaminoethyl acrylate; polymers and copolymers of methacrylate monomers such as methyl methacrylate, ethyl methacrylate, isopropyl methacrylate and butyl methacrylate; polymers and copolymers of acrylonitrile, methacrylonitrile acrylamide, N-iso-pylacrylamide, N-methylolacrylamide and methacrylamide; vinylidene polymers and copolymers such as polyvinylidene chloride, polyvinylidene chloride-polyvinyl chloride, polyvinylidene chloride-polyethyl acrylate and polyvinylidene chloride-polyvinyl chloride-polyacrylonitrile; polymers and copolymers of olefin monomers including ethylene and propylene as well as polymers and copolymers of 1,2-butadiene, 1,3-butadiene, 2-ethyl-1,3-butadiene, and the like; natural latex; polyurethanes, polyamides; polyesters; polymers and copolymers of styrene including styrene, 2-methylstyrene, 3-methylstyrene, 4-methylstyrene, 4-ethylstyrene, and 4-butylstyrene; phenolic emulsions; aminoplast resins and the like. The use of such polymers in back-coating textiles is in the art; see for example U.S. Pat. Nos. 4,737,386 and 4,304,812.

In preferred embodiments, the polymer of the back-coating is either a polymer latex or a polymer plastisol compound, and more preferably is a polymer latex. In some embodiments, the latex polymer used for the back coating includes a polyvinylidene chloride copolymer with at least one acrylic monomer. Standard acrylic monomers include, for example, acrylic acid, methacrylic acid, esters of these acids, or acrylonitrile, ethyl acrylate, butylacryate, glycidyl methacrylate, N-methylolacrylamide, acrylonitrile, 2-hydroxyethyl acrylate, ethylene dimethacrylate, vinyl acetate, butyl acetate, and the like. Alternatively, the back coating may comprise conventional thermoplastic polymers, which can be applied to the textile by hot melt techniques known in the art.

Optionally, the back-coating can include additional components, such as synergists, dyes, wrinkle resist agents, foaming agents, buffers, pH stabilizers, fixing agents, stain repellants such as fluorocarbons, stain blocking agents, soil repellants, wetting agents, softeners, water repellants, stain release agents, optical brighteners, emulsifiers, thickeners, surfactants, and other flame retardants. Preferably, synergists such as Sb₂O₃ are not used.

It should be noted that the flame retardant composition of the present invention may be used in the polymer mentioned above for other applications in addition to polyurethane foams and textiles. For example, it may be used for making a plastic article. The method used in producing a plastic article from the flame retardant resin composition of the present invention is not particularly limited, and any method commonly used may be employed. Exemplary such methods include moldings such as injection molding, blow molding, extrusion, sheet forming, thermal molding, rotational molding, and lamination

The flame retardant composition of the present invention can also be suitably used for electric and electronic equipment parts such as coil bobbins, flyback transformer, connectors and deflecting yoke; electric and electronic materials such as printed wiring boards, printed circuit boards, sealers, electric insulating materials, electric coating agents, laminate sheets, varnish, for high-speed operation, advanced composite materials, electric wires, aerial materials, cables and high-performance molding materials; paints, adhesives, coating materials, tableware, buttons, fiber and paper treating agents, decorative sheets, UV hardening type inks, sealants, synthetic leathers, heat insulating cushioning materials, coating film waterproofing materials, corrosion-resistant linings, binders for molds, lacquers, paints, ink modifying agents, resin modifying materials, aircraft interior parts, matrixes for composite materials, utensils, OA equipments, AV equipments, battery applications, lighting units, automobile parts, housings, ETC, ITC, portable telephones, etc.

The amount of the flame retardant composition added to the polymer as a flame retardant may be varied over a wide range. Usually from about 0.1 to about 100 parts by weight of the flame retardant composition is used per 100 parts by weight of polymer. Preferably about 0.5 to about 30 parts of the flame retardant composition is used per 100 parts by weight of polymer, or from about 2 to about 20 parts by weight per 100 parts by weight of polymer.

The flame retardance test of California Technical Bulletin 117 is for component materials of upholstered furniture. Each type of upholstery filling component must be subjected to both a small open-flame test and a cigarette smoldering test. Specific criteria, including char length, afterflame, afterglow, and/or weight loss must be met for the component to pass the test.

The following examples are presented for purposes of illustration, and are not intended to impose limitations on the scope of this invention. All percentages in the following examples are by weight unless otherwise noted.

### EXAMPLES 1A-1D AND COMPARISON EXAMPLE 1

In order to prove the effectiveness of a flame retardant composition according to the present invention, foams were prepared with and without the flame retardant composition according to the present invention. The flame retardant used in these examples was a mixture of about 10 wt. % of a commercially available cyclic phosphonate flame retardant sold under the tradename Amgard™ CU, and about 90 wt. % isopropyl diphenyl phosphate ester. Comparison example 1 was made with a commercial isopropyl diphenyl phosphate ester with about 27-30% TPP. Examples 1A-1D were made with an isopropyl diphenyl phosphate ester prepared by the procedure in WO2007/127691 and with a TPP content of less than 0.2 wt %.

Foam Preparation: The polyol, surfactant, flame retardant composition, water and triethylamine catalyst were weighed into a half-gallon container in the amounts indicated in Table 1, “php” is parts per hundred polyol. This mixture was then pre-blended with a bow tie agitator at 2000 rpm for 60 seconds or until the mix was homogenous with no visible phase separation. Once mixed, the rpm's were reduced to 500, the timer was started and the blend was mixed for 40 seconds, at which time the TDI (isocyanate) was added. At 50 seconds, the stannous octoate was added and mixing continued until cream time (reaction time) was noted. The mixture was then poured into a 14×14×14 cardboard box and rise time was recorded. Typical cream and rise times observed in this study, depending on density and index, were between 56-59 seconds for cream and 155-170 seconds for rise. Times are from the start of mixing to point of observation.

Flame Retardant Testing: In order to prove the effectiveness of a flame retardant according to the present invention, the flame retardant content of foams made by the process above were varied. Flammability testing was conducted in triplicate and results expressed as a percentage based on California's Technical Bulletin 117, parts A (vertical burn) and/or D (smolder). The Cal 117 part A requires 10 samples for burning, 5 before and 5 after ageing (104° C. for 24 hr). If one fails, from either set, then another 5 are burned from the failed set. Pass fail criteria is based on the following:

Average char length must not exceed 6 inches.

Maximum char length of any individual specimen must not exceed 8 inches.

Average after flame, including after flame of molten material must not exceed 5 seconds

Maximum after flame of any individual specimen must not exceed 10 inches.

Based as a percentage, the test allows 2 failures per 20 samples, or a 90% overall rating as outlined by the above criteria.

In the smolder test, foams are placed in a test stand, with a lite cigarette and a cotton or cotton/polyester blend cover sheeting material. After the test, the charred material is removed and the panel passes if ≦80% by weight of the material remains.

The components, amounts, foam characteristics and flame retardant testing results are listed are listed in Table 1. The results are an average of three 3 lots with 5 samples per each lot (or 15 samples for each test).

TABLE 1

| | Comparison | | | | |
|---|---|---|---|---|---|
| Formulation | Example 1 | Example 1A | Example 1B | Example 1C | Example 1D |
| FR Composition | | | | | |
| Amguard^{a} CU | 10% | 10% | 10% | 10% | 12.5% |
| Aklylated triaryl | 90% | 90% | 90% | 90% | 88.5% |
| phosphate | (~30% TPP)^{b} | (<0.2% TPP)^{b1} | (<0.2 TPP)^{b1} | (<0.2% TPP)^{b1} | (<0.2% TPP)^{b1} |
| Polyurethane Comp | | | | | |
| Polyol^{c} php | 100 | 100 | 100 | 100 | 100 |
| B-8229^{d} | 1.0 | 1.0 | 1.0 | 1.0 | 1.0 |
| Water | 3.75 | 3.75 | 3.75 | 3.75 | 3.75 |
| Fr | 10.0 | 10.0 | 12.0 | 14.0 | 10.0 |
| 33-LV^{e} | 0.30 | 0.30 | 0.30 | 0.30 | 0.30 |
| Kosmos 29^{f} | 0.21 | 0.21 | 0.21 | 0.21 | 0.21 |
| TD1 (Index 105) | 47.2 | 47.2 | 47.2 | 47.2 | 47.2 |
| AirFlow (sccm) | 3.2 | 2.3 | 3.4 | 2.6 | 2.6 |
| Density (pcf) | 1.8 | 1.8 | 1.8 | 1.8 | 1.8 |
| Unaged Cal 117 | | | | | |
| Avg Char length (in) | 3.2 | 4.8 | 3.2 | 3.2 | 3.8 |
| Avg Char flame (sec) | 3.4 | 5.3 | 0.5 | 1.5 | 2.5 |
| Failures | 1 | 4 | 0 | 1 | 1 |
| Unaged Cal 117 | | | | | |
| Avg Char length (in) | 2.9 | 3.9 | 3.1 | 3.3 | 3.4 |
| Avg Char flame (sec) | 1.1 | 3.9 | 1.1 | 1.7 | 2.1 |
| Failures | 1 | 2 | 0 | 1 | 1 |
| Cal 117 pass % | 93.3% | 80.0% | 100.0% | 96.7% | 93.3% |

^{a}Amguard ™ CU is a cyclic phosphanate flame retardant (Rhodia Inc. Cranbury, NJ)
^{b}Phosflex ® 31 L is an isopropylated triphenyl phosphate ester with approximately 30% TPP (Supresta Ardsley, NY)
^{b1}is isopropylated triphenyl phosphate ester made from procedure in WO2007/127691
^{c}Pluracol ® 1388 polyol (a polyether triol having a molecular weight of about 3100; BASF Corporation, Florham Park, NJ).
^{d}Tegostab ® B 8229 surfactant (Evonik Industries AG, Essen, Germany).
^{e}DABCO ® 33-LV triethylamine catalyst (Air Products and Chemicals, Inc, Allentown, PA).
^{f}KOSMOS ® 29 stannous octoate catalyst (Evonik Industries AG, Essen, Germany).

### EXAMPLES 2A-2C AND COMPARISON EXAMPLE 2

The tests of Examples 1A-1D were repeated with the formulations below. Only one sample per lot was tested for the California smolder test.

TABLE 2

| | Comparison | Example | Example | Example |
|---|---|---|---|---|
| Formulation | Example 2 | 2A | 2B | 2C |
| FR Composition | | | | |
| Amguard^{a} CU | 10% | 10% | 10% | 11.5% |
| Aklylated triaryl | 90% | 90% | 90% | 88.5% |
| phosphate | (~30% | (<0.2% | (<0.2 | (<0.2% |
| | TPP)^{b} | TPP)^{b1} | TPP)^{b1} | TPP)^{b1} |
| Polyurethane Comp | | | | |
| Polyol^{c} php | 100 | 100 | 100 | 100 |
| B-8229^{d} | 1.0 | 1.0 | 1.0 | 1.0 |
| Water | 3.70 | 3.70 | 3.70 | 3.70 |
| FR composition | 10.0 | 10.0 | 12.0 | 10.0 |
| 33-LV^{e} | 0.30 | 0.30 | 0.30 | 0.30 |
| T-9^{f} | 0.21 | 0.21 | 0.21 | 0.21 |
| TD1 (Index 105) | 47.2 | 47.2 | 47.2 | 47.2 |
| Airflow (sccm) | 3.0 | 2.4 | 2.2 | 3.1 |
| Density (pcf) | 1.7 | 1.7 | 1.7 | 1.7 |
| Unaged Cal 117 | | | | |
| Avg Char length (in) | 2.5 | 2.5 | 2.6 | 2.3 |
| Avg Char flame (sec) | 0 | 0 | 1.5 | 2.8 |
| Failures | 0 | 0 | 1 | 1 |
| Unaged Cal 117 | | | | |
| Avg Char length (in) | 2.9 | 3.2 | 2.8 | 2.3 |
| Avg Char flame (sec) | 0 | 3.5 | 1.7 | 0.3 |
| Failures | 1 | 2 | 1 | 0 |
| Smolder | | | | |
| Lot A | 93.5% | 91.5% | 83.3% | 91.1% |
| Lot B | 93.8% | 89.5% | 77.0% | 89.3% |
| Lot C | 89.0% | 90.9% | 79.9% | 85.8% |
| Cal 117 pass % | 100% | 93.3% | 93.3% | 96.7% |

The results demonstrate that the formulations with the low TPP content perform comparable to the sample with high TPP loadings. This is surprising since TPP is an excellent flame retardant component and alkylated flame retardants with low TPP content are generally not effective.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and for reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention described and claimed herein is not to be limited in scope by the specific examples and embodiments herein disclosed, since these examples and embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fail within the scope of the appended claims.

1. A phosphorus flame retardant composition formed from bringing together components comprising:
a) a cyclic phosphanate flame retardant comprising (5-ethyl-2-methyl-2-oxido-1,3,2-dioxaphosphorinan-5-yl)methyl methyl ester of P-alkylphosphonic acid (Cas # 41203-81-0), and bis[(5-ethyl-2-methyl-2-oxido-1,3,2-dioxaphosphorinan-5-yl)methyl]ester of P-alkylphosphonic acid (Cas # 42595-45-9); and
b) an alkylated triaryl phosphate ester flame retardant having a triphenyl phosphate (TTP) content of less than about 1 wt % based on the total weight of the alkylated triaryl phosphate ester.

2. The composition of claim 1, wherein the amount of said cyclic phosphanate flame retardant is about 8 wt % to about 11.5 wt % based on the total weight of said cyclic phosphanate flame retardant and alkylated triaryl phosphate ester flame retardant.

3. The composition of claim 1 wherein said two diesters of P-alkylphosphonic acid are diesters of P-methylphosphonic acid.

4. The composition of claim 1 wherein the cyclic phosphonate flame retardant contains in the range of from about 60 wt. % to about 90 wt. % (5-ethyl-2-methyl-2-oxido-1,3,2-dioxaphosphorinan-5-yl)methyl methyl ester of P-alkylphosphonic acid (monomer), and in the range of from about 10 wt. % to about 40 wt. % bis[(5-ethyl-2-methyl-2-oxido-1,3,2-dioxaphosphorinan-5-yl)methyl]ester of P-alkylphosphonic acid (dimer), based on the total weight of the monomer and dimer.

5. The composition according to claim 1 wherein said alkylated triaryl phosphate ester contains one or more of the following alkylated phenyl phosphates: a) monoalkylphenyl diphenyl phosphates; b) di-(alkylphenyl) phenyl phosphates; c) dialkylphenyl diphenyl phosphates; d) trialkylphenyl phosphates; e) alkylphenyl dialkylphenyl phenyl phosphates, wherein the alkyl moieties of the alkylated phenyl phosphates and TPP are selected from methyl, ethyl, n-propopyl, isopropyl, isobutyl, tertiary-butyl, isoamyl and tertiary-amyl groups.

6. The composition according to claim 4 wherein said alkylated triaryl phosphate ester comprises in the range of from about a) 90 to about 92 wt. % an isopropylphenyl diphenyl phosphate, in the range of from about 0.5 to about 0.75 wt. % tri(isopropylphenyl)phosphate, in the range of from about 1 to about 3 wt. % di-(isopropylphenyl)phenyl phosphate, in the range of from about 0.05 to about 0.15 wt. % triphenyl phosphate, and in the range of from about 0.5 to about 0.75 wt. % di-isopropylphenyl diphenyl phosphate; or b) in the range of from about 94 to about 96 wt. % isopropylphenyl diphenyl phosphate, in the range of from about 3.5 to about 5.5 wt. % di-(isopropylphenyl)phenyl phosphate, and in the range of from about 0.1 to about 0.3 wt. % tri(isopropylphenyl)phosphate; or c) in the range of from about 71 to about 73 wt. % isopropylphenyl diphenyl phosphate, in the range of from about 0.05 to about 0.15 wt. % triphenyl phosphate, in the range of from about 26 to about 28 wt. % di-(isopropylphenyl)phenyl phosphate, and in the range of from about 0.5 to about 0.7 wt. % tri(isopropylphenyl)phosphate.

7. A polyurethane foam composition, comprising (i):
a) the phosphorus flame retardant composition of claim 1;
b) an isocyanate or polyisocyanate;
c) a polyol along with at least one surfactant,
d) at least one blowing agent, and
e) at least one catalyst.

8. The polyurethane foam composition of claim 7 wherein said foam is flexible or rigid and wherein when said foam is a flexible polyurethane foam, said polyol is a polyether polyol, and when said foam is a rigid polyurethane foam, said polyol has a hydroxyl number in the range of about 150 to about 850 mg KOH/g.

9. A textile to which the phosphorus flame retardant composition of claim 1 has been applied.

10. The textile of claim 9, wherein said textile has a back-coating, and wherein said phosphorus flame retardant composition is included in said back-coating.

11. An article, wherein said article is a coating, adhesive, sealer or elastomer and wherein said article comprises the phosphorus flame retardant composition of claim 1.
